(19) United States
(12) Patent Application Publication
(10) Pub. No.: US 2026/0320151 A1
(43) Pub. Date: Oct. 15, 2026

(54) MATRIX INDEX INFORMATION GENERATION METHOD AND DEVICE, AND MATRIX PROCESSING METHOD AND DEVICE USING MATRIX INDEX INFORMATION

(71) Applicant: INDUSTRY ACADEMY COOPERATION FOUNDATION OF SEJONG UNIVERSITY, Seoul (KR)

(72) Inventors: Gi Ho PARK, Seoul (KR); Chi Won HAN, Seoul (KR)

(21) Appl. No.: 19/705,105

(22) Filed: Jun. 11, 2026

Related U.S. Application Data
(63) Continuation of application No. PCT/KR2024/021207, filed on Dec. 27, 2024.

(30) Foreign Application Priority Data
Dec. 27, 2023 (KR) 10-2023-0192177
Jan. 29, 2024 (KR) 10-2024-0013088
Feb. 26, 2024 (KR) 10-2024-0027135
Dec. 20, 2024 (KR) 10-2024-0192881
Dec. 20, 2024 (KR) 10-2024-0192885

(51) Int. Cl. G06F 17/16

(52) U.S. Cl. CPC G06F 17/16

(57) ABSTRACT

Provided are a method of generating matrix index information and a method of processing a matrix using matrix index information. The disclosed method of generating matrix index information includes: identifying non-zero elements in a target matrix; and generating matrix index information including quantization information of the target matrix, data size information of the target matrix and position information of non-zero elements.

### CROSS-REFERENCE TO RELATED APPLICATION

This application is a bypass continuation of pending PCT International Application No. PCT/KR2024/021207, which was filed on Dec. 27, 2024, and which claims priority to Korean Patent Application No. 10-2023-0192177 which was filed in the Korean Intellectual Property Office on Dec. 27, 2023, Korean Patent Application No. 10-2024-0013088 which was filed in the Korean Intellectual Property Office on Jan. 29, 2024, Korean Patent Application No. 10-2024-0027135 which was filed in the Korean Intellectual Property Office on Feb. 26, 2024, Korean Patent Application No. 10-2024-0192885 which was filed in the Korean Intellectual Property Office on Dec. 20, 2024, and Korean Patent Application No. 10-2024-0192881 which was filed in the Korean Intellectual Property Office on Dec. 20, 2024. The disclosures of which are hereby incorporated by reference in their entireties.

### TECHNICAL FIELD

The present disclosure relates to a method and device for generating matrix index information and a method and device for processing a matrix using matrix index information, and more particularly, to a method and device for generating index information of a target matrix including a sparse matrix and a method and device for processing a matrix using matrix index information.

### BACKGROUND ART

With the recent development of neural network models, such as convolutional neural network (CNN) models utilized in areas of service including image recognition, etc., the depth of layers, etc., to be processed by a neural network model is increasing. This factor has led to an increase in the number of parameters, such as weight matrices, of a neural network model, making high memory overhead a significant issue.

To solve this problem, studies have been carried out on a matrix indexing method for efficiently performing computation on a sparse matrix using the fact that a pruning technique which is performed to solve the overfitting problem of a neural network model makes a weight matrix a sparse matrix. As a method of indexing a sparse matrix, compressed sparse row (CSR) is frequently utilized. A processing element, such as an arithmetic logic unit (ALU), of a processor loads matrix data from a memory using matrix index information which is generated through a matrix indexing method, and performs computation on a matrix using the loaded matrix data.

In addition, a quantization technique for reducing the data size of matrix elements is utilized to efficiently perform matrix computation of a neural network model. For example, matrix elements represented in 32 bits may be quantized to smaller bits, such as 16 bits or 8 bits, for computation.

Lately, mixed-precision quantization for adjusting quantization bits of matrix elements in accordance with the importance of the elements or whether computation with outliers is performed has been gaining attention.

### DISCLOSURE

### Technical Problem

The present disclosure is directed to providing a matrix index information generation method and a matrix processing method for reducing the number of memory accesses by enhancing memory access efficiency.

The present disclosure is also directed to providing a matrix data transmission and processing method for efficient matrix computation.

The present disclosure is also directed to providing a method and device for generating index information of a computational area of an operand matrix and a method and device for processing a matrix using index information of a computational area of an operand matrix.

The present disclosure is also directed to providing a matrix index information generation method and device and a matrix processing method and device for reducing the number of memory accesses for matrix computation.

The present disclosure is also directed to providing a method and device for generating matrix index information including feature information of matrix elements and a method and device for processing a matrix using matrix index information including feature information of matrix elements.

### Technical Solution

According to an embodiment of the present disclosure for achieving the foregoing objects, a method of generating matrix index information is provided, including: identifying non-zero elements in a target matrix; and generating matrix index information including quantization information of the target matrix, data size information of the target matrix, and position information of the non-zero elements.

According to another embodiment of the present disclosure for achieving the foregoing objects, a method of generating different pieces of matrix index information is provided, including: identifying non-zero elements in a target matrix; and generating matrix index information including data size information of the target matrix and position information of each of the non-zero elements. A bitstring indicating the position information includes bits corresponding to each of positions of elements in the target matrix, and in the bitstring, a bit value corresponding to positions of zero elements in the target matrix and a bit value corresponding to positions of the non-zero elements are different.

According to another embodiment of the present disclosure for achieving the foregoing objects, a method of generating matrix index information is provided, including: identifying non-zero elements in a target matrix; and generating matrix index information including quantization information of the target matrix, count information of the non-zero elements, and position information of the non-zero elements.

According to another embodiment of the present disclosure for achieving the foregoing objects, a method of generating matrix index information is provided, including: identifying non-zero elements in a target matrix; and generating matrix index information including quantization information of the target matrix and position information of each of the non-zero elements. A bitstring indicating the position information includes bits corresponding to each of positions of elements in the target matrix, and in the bitstring, a bit value corresponding to positions of zero elements in the target matrix and a bit value corresponding to positions of the non-zero elements are different.

According to another embodiment of the present disclosure for achieving the foregoing objects, a method of processing a matrix using matrix index information is provided, including: loading non-zero elements of a first target matrix from a memory using matrix index information of the first target matrix; and transmitting the loaded data to processing units. The matrix index information includes quantization information of the first target matrix, data size information of the first target matrix, and position information of the non-zero elements.

According to another embodiment of the present disclosure for achieving the foregoing objects, a method of processing a matrix using matrix index information is provided, including: loading non-zero elements of a first target matrix from a memory using matrix index information of the first target matrix; and transmitting the loaded data to processing units. The matrix index information includes quantization information of the first target matrix, count information of the non-zero elements, and position information of the non-zero elements.

According to another embodiment of the present disclosure for achieving the foregoing objects, a method of transmitting matrix data is provided, including: selecting elements required for computation of a first matrix and a second matrix among elements of the first and second matrices using matrix index information of the first and second matrices; and transmitting the selected elements to an upper memory or processing units.

According to another embodiment of the present disclosure for achieving the foregoing objects, a method of transmitting matrix data is provided, including: selectively loading elements required for computation of a first matrix and a second matrix among elements of the first and second matrices stored in a lower memory to an upper memory or processing units using matrix index information of the first and second matrices; and performing computation of the first and second matrices using the loaded elements.

According to another embodiment of the present disclosure for achieving the foregoing objects, a method of transmitting matrix data is provided, including: identifying non-zero elements among elements of a first matrix and a second matrix using matrix index information of the first and second matrices; and transmitting memory address values of the non-zero elements generated from the matrix index information and the non-zero elements to an upper memory or processing units.

According to another embodiment of the present disclosure for achieving the foregoing objects, a method of processing matrix data is provided, including: loading non-zero elements among elements of a first matrix and a second matrix stored in a lower memory using matrix index information of the first and second matrices and loading memory address values of the non-zero elements into an upper memory; and performing computation of the first and second matrices using non-zero elements selected among the loaded non-zero elements in accordance with the memory address values.

According to another embodiment of the present disclosure for achieving the foregoing objects, a method of generating matrix index information is provided, including: determining a computational area of a first operand matrix that is computed with non-zero elements of a second operand matrix; and generating submatrix index information of the computational area using non-zero elements included in the computational area.

According to another embodiment of the present disclosure for achieving the foregoing objects, a method of processing a matrix using matrix index information which is submatrix index information is provided, including: loading elements of a first operand matrix and a second operand matrix using matrix index information of the first and second operand matrices; and performing computation of the loaded elements. The matrix index information of the first operand matrix is generated using non-zero elements included in a computational area of the first operand matrix, that are computed with non-zero elements of the second operand matrix.

According to another embodiment of the present disclosure for achieving the foregoing objects, a device for generating matrix index information is provided, including: a memory; and a processor electrically connected to the memory. The processor determines a computational area of a first operand matrix that is computed with non-zero elements of a second operand matrix; and generating submatrix index information of the computational area using non-zero elements included in the computational area.

According to another embodiment of the present disclosure for achieving the foregoing objects, a device for processing a matrix using matrix index information which is submatrix index information is provided, including: a memory; and a processor electrically connected to the memory. The processor loads elements of a first operand matrix and a second operand matrix using matrix index information of the first and second operand matrices and performs computation of the loaded elements. The matrix index information of the first operand matrix is generated using non-zero elements included in a computational area of the first operand matrix, that are computed with non-zero elements of the second operand matrix.

According to another embodiment of the present disclosure for achieving the foregoing objects, a method of generating matrix index information is provided, including: identifying non-zero elements in a target matrix for a deep learning model; and generating matrix index information including feature information of the non-zero elements. The feature information includes at least one of information indicating whether the target matrix is computed with outlier elements of an operand matrix and lightweighting information of the deep learning model.

According to another embodiment of the present disclosure for achieving the foregoing objects, a method of generating matrix index information is provided, including: loading a target matrix for a deep learning model; and generating matrix index information including feature information of elements of the target matrix. The feature information includes at least one of information indicating whether the target matrix is computed with outlier elements of an operand matrix and lightweighting information of the deep learning model.

According to another embodiment of the present disclosure for achieving the foregoing objects, a method of processing a matrix using matrix index information is provided, including: loading matrix index information of a target matrix for a deep learning model; and performing lightweighting on the deep learning model using the matrix index information. The matrix index information includes feature information of non-zero elements of the target matrix, and the feature information includes at least one of information indicating whether the target matrix is computed with outlier elements of an operand matrix and lightweighting information of the deep learning model.

According to another embodiment of the present disclosure for achieving the foregoing objects, a device for generating matrix index information is provided, including: a memory configured to store elements of a target matrix for a deep learning model; and a processor electrically connected to the memory. The processor identifies non-zero elements in the target matrix and generates matrix index information including feature information of the non-zero elements, and the feature information includes at least one of information indicating whether the target matrix is computed with outlier elements of an operand matrix and lightweighting information of the deep learning model.

According to another embodiment of the present disclosure for achieving the foregoing objects, a device for generating matrix index information using matrix index information is provided, including: a memory configured to store matrix index information of a target matrix for a deep learning model; and a processor electrically connected to the memory. The processor performs lightweighting on the deep learning model using the matrix index information, the matrix index information includes feature information of non-zero elements of the target matrix, and the feature information includes at least one of information indicating whether the target matrix is computed with outlier elements of an operand matrix and lightweighting information of the deep learning model.

### Advantageous Effects

According to an embodiment of the present disclosure, data is loaded through memory access in accordance with a data size of a matrix. Therefore, memory access efficiency is enhanced, and the number of memory accesses is reduced, thereby reducing power consumption.

According to an embodiment of the present disclosure, data sizes of matrices are standardized to correspond to multiples or divisors of a unit data block size loaded through memory access, and thus data of a plurality of matrices can be loaded simultaneously. Therefore, memory access efficiency can be further enhanced.

According to an embodiment of the present disclosure, data required for matrix computation is selectively transmitted from a lower memory to an upper memory or processing units without matrix index information transmitted from the lower memory to the upper memory or the processing units, thereby improving the speed and efficiency of matrix computation.

According to an embodiment of the present disclosure, elements included in a computational area of a second operand matrix which is computed with a first operand matrix are selectively loaded and used for computation.

According to an embodiment of the present disclosure, elements included in a computational area of a second operand matrix which is computed with a first operand matrix are selectively loaded in accordance with matrix index information, thereby reducing the number of memory accesses.

According to an embodiment of the present disclosure, lightweighting can be efficiently performed on a deep learning model by checking matrix index information including feature information of non-zero elements.

According to an embodiment of the present disclosure, quantization is not performed or less aggressive quantization is performed on non-zero elements that are computed with outlier elements, by checking matrix index information including feature information of non-zero elements.

According to an embodiment of the present disclosure, pruning is performed in accordance with pruning priority by checking matrix index information including feature information of non-zero elements, thereby mitigating the problem of accuracy degradation that may be caused by pruning.

### DESCRIPTION OF DRAWINGS

FIG. 1 is a diagram illustrating a method of generating matrix index information according to an embodiment of the present disclosure.

FIG. 2 is a diagram showing matrix index information according to the embodiment of the present disclosure.

FIG. 3 is a diagram illustrating a method of generating matrix index information according to another embodiment of the present disclosure.

FIG. 4 is a diagram showing matrix index information according to the other embodiment of the present disclosure.

FIG. 5 is a diagram illustrating a device for processing a matrix using matrix index information according to an embodiment of the present disclosure.

FIG. 6 is a diagram illustrating a method of processing a matrix using matrix index information according to an embodiment of the present disclosure.

FIG. 7 is a diagram showing memory storage data according to an embodiment of the present disclosure.

FIG. 8 is a diagram illustrating a device for processing matrix data according to an embodiment of the present disclosure.

FIG. 9 is a diagram illustrating a method of transmitting matrix data according to an embodiment of the present disclosure.

FIG. 10 is a diagram illustrating a method of selecting elements required for computation.

FIG. 11 is a diagram illustrating a method of transmitting matrix data according to another embodiment of the present disclosure.

FIG. 12 is a diagram illustrating memory address values of non-zero elements.

FIG. 13 is a diagram illustrating a method of processing matrix data according to an embodiment of the present disclosure.

FIG. 14 is a diagram illustrating a method of processing matrix data according to another embodiment of the present disclosure.

FIG. 15 is a diagram illustrating a convolution operation of a matrix.

FIG. 16 is a diagram illustrating a method of generating matrix index information according to still another embodiment of the present disclosure.

FIG. 17 is a diagram illustrating a method of generating submatrix index information according to an embodiment of the present disclosure.

FIG. 18 is a diagram illustrating a method of generating submatrix index information according to another embodiment of the present disclosure.

FIG. 19 is a diagram illustrating a method of processing a matrix using matrix index information according to another embodiment of the present disclosure.

FIG. 20 is a diagram illustrating a method of generating matrix index information according to yet another embodiment of the present disclosure.

FIG. 21 is a diagram showing matrix index information according to another embodiment of the present disclosure.

FIG. 22 is a diagram illustrating a method of processing a matrix according to still another embodiment of the present disclosure.

### MODES OF THE INVENTION

While the present disclosure can be variously modified and have several embodiments, specific embodiments will be illustrated in the drawings and described in detail. However, this is not intended to limit the present disclosure to the specific embodiments, and it should be understood that the present disclosure includes all modifications, equivalents, and substitutions within the spirit and technical scope of the present disclosure. In describing each drawing, like reference numerals are used for like components.

The present disclosure relates to a method of generating matrix index information and a method of processing a matrix using matrix index information or transmitting matrix data, and an embodiment of the present disclosure proposes a matrix index information generation method and a matrix processing method for reducing the number of memory accesses by enhancing memory access efficiency. Also, another embodiment of the present disclosure proposes a matrix data transmission and processing method for efficient matrix computation. Also, another embodiment of the present disclosure proposes a method and device for generating index information of a computational area of an operand matrix and a method and device for processing a matrix using index information of a computational area of an operand matrix. Also, another embodiment of the present disclosure proposes a method and device for generating matrix index information including feature information of matrix elements and a method and device for processing a matrix using matrix index information including feature information of matrix elements.

Hereinafter, embodiments of the present disclosure will be described in detail with reference to the accompanying drawings.

### First Embodiment

As described above, a quantization technique is used for efficient matrix computation, and quantization may be applied to matrices in accordance with different quantization bits. Here, quantization bits correspond to the number of bits to which matrix elements are quantized. For example, quantization bits that are 16 bits indicate that matrix elements have been quantized into 16-bit values.

Also, a data size of a matrix is determined to be a product of quantization bits and the number of non-zero elements. Accordingly, when different matrix quantization bits are set for matrices, a size of matrix data loaded through memory access varies depending on matrices even with the same number of non-zero elements. However, currently used matrix index information, such as compressed sparse row (CSR), does not include information on matrix quantization bits, not allowing memory access based on a matrix data size. Accordingly, memory access efficiency is degraded, and power consumption increases with an increase in the number of memory accesses.

Therefore, to enhance the efficiency of memory access for loading matrix data and reduce power consumed by memory access, the present disclosure proposes a method of generating matrix index information including quantization information of a matrix and processing a matrix using the matrix index information.

In particular, according to an embodiment of the present disclosure, matrix data sizes are standardized, and information on these matrix data sizes is included in matrix index information. In this way, according to the embodiment of the present disclosure, efficiency of memory access for loading matrix data can be further enhanced.

A matrix index information generation method and a matrix processing method according to an embodiment of the present disclosure may be performed by a computing device including a memory and a processor, and the processor may be a general-purpose processor or a separate processor such as a deep learning accelerator for artificial intelligence computation.

Hereinafter, embodiments of the present disclosure will be described in detail with reference to the accompanying drawings.

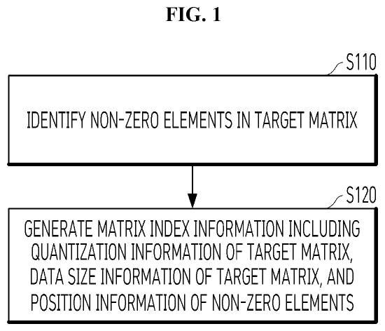

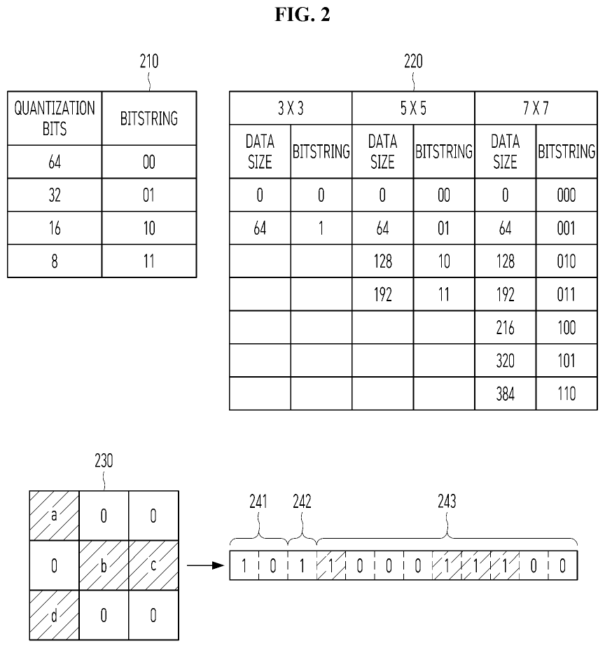

FIG. 1 is a diagram illustrating a method of generating matrix index information according to an embodiment of the present disclosure, and FIG. 2 is a diagram showing matrix index information according to the embodiment of the present disclosure.

Referring to FIG. 1, a computing device according to the embodiment of the present disclosure identifies non-zero elements in a target matrix (S110). According to an embodiment, the target matrix may be a weight matrix including weight values of an artificial neural network, and the computing device may determine the number and positions of the non-zero elements in the target matrix by identifying the non-zero elements of the target matrix.

The computing device generates matrix index information including quantization information of the target matrix, data size information of the target matrix, and position information of the non-zero elements (S120). The matrix index information may be a bitstring and may include a first bitstring indicating the quantization information, a second bitstring indicating the data size information, and a third bitstring indicating the position information. Here, a bitstring refers to a sequence including at least one bit.

As described above, the quantization information is information on quantization bits indicating the number of bits to which non-zero elements of the target matrix have been quantized, and may be set to various values depending on embodiment. The data size of the target matrix may be determined in accordance with the quantization bits and the number of non-zero elements and may be one of preset candidate data sizes. The candidate data size may be determined in accordance with a size of unit data blocks that are loaded through memory access. According to an embodiment, the data size of the target matrix may be determined to be a multiple or divisor of the size of unit data blocks loaded through memory access. Also, the unit data block size is a size of data that may be efficiently loaded into a memory. For example, the unit data block size may be the number of bits of a data bus connected to a memory into which data will be loaded or a unit data size with high transmission efficiency that is determined by transmission operation characteristics of the memory into which data will be loaded.

For example, referring to FIG. 2, the quantization bits may be set to 64 bits, 32 bits, 16 bits, or 8 bits as shown in a first table 210, and bitstrings may be mapped to quantization bits. As shown in a second table 220, the candidate data size of the matrix may be set in accordance with the size of the matrix, and bitstrings may be mapped to candidate data sizes. Candidate data sizes of a 3×3 matrix may be set to 0 bits and 64 bits, candidate data sizes of a 5×5 matrix may be set to 0 bits, 64 bits, 128 bits, and 192 bits, and candidate data sizes of a 7×7 matrix may be set to 0 bits, 64 bits, 128 bits, 192 bits, 256 bits, 320 bits, and 384 bits. Here, 64 bits correspond to the unit data block size, and 128, 192, 256, 320, and 384 are all multiples of 64. When the unit data block size changes, candidate data sizes of a matrix may also change.

When quantization bits of a target matrix 230 are 16 bits, a bit value of a first bitstring 241 is determined to be 10 on the basis of the first table 210. A data size of the target matrix 230 corresponds to a product of the number of non-zero elements and the quantization bits, and the 3×3 target matrix 230 has four non-zero elements a, b, c, and d. Accordingly, a bit value of a second bitstring 242 is determined to be 1.

According to an embodiment, a third bitstring 243 includes bits corresponding to positions of elements in the target matrix. In the third bitstring 243, different values may be assigned as a bit value corresponding to positions of zero elements in the target matrix and a bit value corresponding to positions of the non-zero elements. For example, the bit value corresponding to the positions of the zero elements may be 0, and the bit value corresponding to the positions of the non-zero elements may be 1. Therefore, in the example of FIG. 2, the third bitstring 243 may be determined to be 100011100. There is no limitation on a format of the third bitstring indicating position information, and a bitstring used in CSR to represent position information may be used as the third bitstring.

Meanwhile, as described above, a data size of a target matrix corresponds to a product of the number of non-zero elements and quantization bits, and the computing device may adjust quantization bits or the number of non-zero elements in the target matrix to standardize a data size of a target matrix to a preset size.

According to an embodiment, the computing device may adjust the number of non-zero elements in accordance with quantization bits such that a data size of a target matrix becomes a multiple or divisor of a unit data block size. In other words, when quantization bits are set, the computing device may adjust the number of non-zero elements in accordance with the set quantization bits. The computing device may adjust the number of non-zero elements by reducing the number of non-zero elements through pruning.

In the example of FIG. 2, when the number of non-zero elements in the target matrix 230 is five, the computing device may change one of the five non-zero elements to a zero element through pruning such that a data size of the target matrix becomes 64 bits. Here, the non-zero element changed to the zero element may be determined in accordance with a pruning algorithm.

Alternatively, the computing device may adjust the number of quantization bits in accordance with the number of non-zero elements such that the data size of the target matrix becomes a multiple or divisor of a unit data block size. In other words, when the number of non-zero elements is determined through pruning, etc., the computing device may adjust quantization bits in accordance with the determined number of non-zero elements.

In the example of FIG. 2, when the number of non-zero elements in the target matrix 230 is reduced to two through pruning, the quantization bits may be adjusted to 32 bits. In this case, the computing device determines the first bitstring 241 to be 01.

Using this matrix index information, the computing device can load data of the target matrix from the memory in a size of a multiple or divisor of the unit data block size, distinguish each non-zero element in the loaded data, and determine positions of non-zero elements.

Meanwhile, according to embodiments, the computing device may identify non-zero elements in a target matrix and generate matrix index information including data size information of the target matrix and position information of each of the non-zero elements. In other words, the computing device may generate matrix index information not including quantization information of the target matrix.

The foregoing third bitstring 243 includes both position information of the non-zero elements and count information of the non-zero elements. When this bitstring is used as position information, quantization information may be estimated from the matrix index information and thus may be omitted from the matrix index information. In the example of FIG. 2, it may be estimated from the number of 1s in the third bitstring 243 that the number of non-zero elements in the target matrix is four, and the data size of the target matrix is 64 bits. Accordingly, it may be estimated that quantization bits of the non-zero elements is 16 bits.

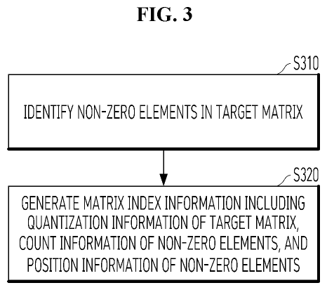

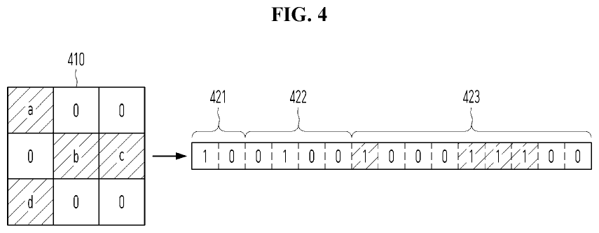

FIG. 3 is a diagram illustrating a method of generating matrix index information according to another embodiment of the present disclosure, and FIG. 4 is a diagram showing matrix index information according to the other embodiment of the present disclosure.

Referring to FIG. 3, a computing device according to an embodiment of the present disclosure identifies non-zero elements in a target matrix (S310) and generates matrix index information including quantization information of the target matrix, count information of non-zero elements, and position information of the non-zero elements (S320).

The matrix index information may include a first bitstring indicating quantization information, a second bitstring indicating the count information, and a third bitstring indicating the position information. Here, the second bitstring is a bitstring indicating the count information in binary numbers.

As shown in FIG. 4, when a target matrix 410 include four non-zero elements and quantization bits of the non-zero elements are 16 bits, the first bitstring 421 may be set to 10, the second bitstring 422 may be set to 0100, and the third bitstring 423 may be set to 100011100.

The computing device may calculate a data size of the target matrix from the matrix index information and load data about the target matrix from a memory in accordance with the calculated data size. In the example of FIG. 4, the quantization bits are 16 bits, the number of non-zero elements is four, and thus the data size of the target matrix 410 is 64 bits. Accordingly, the computing device may load 64-bit data from the memory.

Meanwhile, according to embodiments, the computing device may identify the non-zero elements in the target matrix and generate matrix index information including quantization information of the target matrix and position information of each of the non-zero elements. In other words, when the position information of non-zero elements is assigned per non-zero element position, the computing device may generate matrix index information not including count information of non-zero elements.

Since the foregoing third bitstring 423 include both the position information of the non-zero elements and the count information of the non-zero elements, when such a bitstring is used as position information, count information of non-zero elements may be omitted from matrix index information. In the example of FIG. 4, it may be estimated from the number of 1s in the third bitstring 423 that the number of non-zero elements in the target matrix is four.

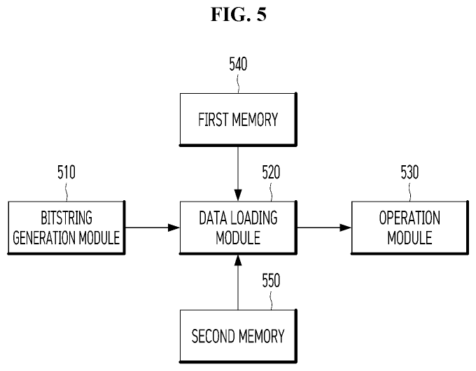

FIG. 5 is a diagram illustrating a device for processing a matrix using matrix index information according to an embodiment of the present disclosure.

Referring to FIG. 5, the device for processing a matrix according to the embodiment of the present disclosure includes a bitstring generation module 510, a data loading module 520, and a operation module 530. According to embodiments, a memory may be further included. The device for processing a matrix according to the embodiment of the present disclosure may be an example of the foregoing computing device.

The bitstring generation module 510 generates matrix index information. The bitstring generation module 510 may generate matrix index information of a first target matrix as described in the above embodiment.

The data loading module 520 may identify a data size of the first target matrix using the matrix index information of the first target matrix and access a first memory 540 to load non-zero element data corresponding to the data size of the first target matrix from the first memory 540. The data loading module 520 may load the non-zero element data of the first target matrix at once using a burst mode or the like.

When data size information of the target matrix is included in the matrix index information, the data loading module 520 may determine the data size of the first target matrix from the data size information. Alternatively, when the matrix index information includes quantization information of the target matrix and count information of non-zero elements, the data loading module 520 may determine the data size of the first target matrix from quantization bits and the count information.

To identify the data size of the first target matrix from the matrix index information, the data loading module 520 may use the second table 220 in which data sizes are mapped to bit values.

Also, the data loading module 520 may load the non-zero element data of the first target matrix using memory address values of non-zero elements stored in the first memory 540. According to an embodiment, the memory address values assigned to the non-zero element data may have a sequential form in accordance with preset rules, and memory address values for non-zero element data of a plurality of target matrices may be assigned in a sequential pattern to correspond to the order of indexes assigned to the target matrix. Therefore, the data loading module 520 can determine the address values of the non-zero elements of the first target matrix using the number of non-zero elements previously loaded from the memory and load the non-zero elements of the first target matrix from the first memory 540 using the determined memory address values.

The operation module 530 performs computation for the first target matrix using the loaded data. The operation module 530 may perform computation of elements of a second target matrix additionally loaded by the data loading module 520 and the non-zero elements of the first target matrix. The elements of the second target matrix may be stored in a second memory 550, and the second target matrix may also be stored in the second memory 550 together with the matrix index information in the same manner as the first target matrix.

The operation module 530 may include a plurality of processing units for parallel computation, and the non-zero elements of the first target matrix and non-zero elements of the second target matrix may be assigned to each of the processing units. Each processing unit may perform computation of the assigned non-zero element of the first target matrix and the assigned non-zero element of the second target matrix.

The data loading module 520 transmits the loaded data to the operation module 530. Here, the matrix index information may be used to distinguish the loaded data into each piece of non-zero element data, and the distinguished non-zero elements may be transmitted to each of the processing units. The data loading module 520 may determine each piece of the non-zero element data by dividing the loaded data into units of quantization data bits using the quantization information and may use the first table 210 in which quantization bits are mapped to bit values to determine quantization bits.

In addition, the data loading module 520 may identify not only positions of the non-zero elements in the first target matrix but also positions of the non-zero elements in the second target matrix using position information. Therefore, the data loading module 520 may transmit one pair of non-zero elements in a computational relationship among the non-zero elements of the first and second target matrices to each processing unit.

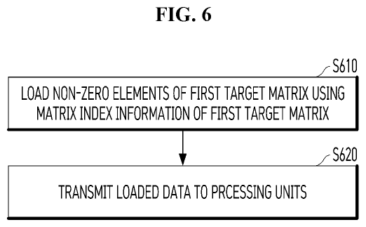

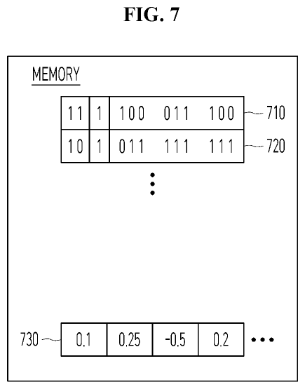

FIG. 6 is a diagram illustrating a method of processing a matrix using matrix index information according to an embodiment of the present disclosure, and FIG. 7 is a diagram showing memory storage data according to an embodiment of the present disclosure.

Referring to FIG. 6, a device for processing a matrix according to an embodiment of the present disclosure loads non-zero elements of a first target matrix from a memory using matrix index information of the first target matrix (S610). The matrix index information may include quantization information of the first target matrix, data size information of the first target matrix, and position information of non-zero elements or may include the data size information and the position information without the quantization information.

A size of the loaded data is determined in accordance with the data size information of the first target matrix, and a data size of the first target matrix may correspond to a multiple or divisor of a unit data block size loaded through memory access. In other words, the device for processing a matrix may load data whose size corresponds to the data size of the first target matrix from the memory.

As shown in FIG. 7, matrix index information 710 and 720 of target matrices and non-zero elements 730 may be stored in the memory. FIG. 7 shows an example in which index information of a 3×3 target matrix is stored in the memory. When a first bitstring is 11, a second bitstring is 1, and a third bitstring is 100011100 in the matrix index information 710 of a first target matrix, quantization bits are 16 bits and a data size is 64 bits in accordance with the first and second tables 210 and 220. Accordingly, when the unit data block size is 64 bits or more, the device for processing a matrix may load 64-bit data from the memory. Then, the loaded 64-bit data may be divided into 16-bit units, and the divided 16-bit data units may correspond to 0.1, 0.25, −0.5, and 0.2 which are the non-zero elements 730.

When the data size of the first target matrix is smaller than the unit data block size, the device for processing a matrix may also load non-zero elements of the first target matrix and non-zero elements of the second target matrix. For example, when the unit data block size is 128 bits, the unit data block size is larger than 64 bits that are the data size of the first target matrix. Accordingly, the device for processing a matrix may load the non-zero elements of the first target matrix and all or some non-zero elements of the second target matrix together using the matrix index information 720 of the second target matrix. In the example of FIG. 7, the data sizes of the first and second target matrices are 64 bits. Therefore, when the unit data block size is 128 bits, all the non-zero elements of the first and second target matrices may be loaded from the memory at once through memory access.

Referring back to FIG. 6, in operation S610, the device for processing a matrix may load elements of a third target matrix that is computed with the first target matrix, from the memory. Here, position information of the first target matrix may be used to load only elements that are multiplied by the non-zero elements of the first target matrix, among the elements of the third target matrix from the memory.

Then, the device for processing a matrix may transmit the data loaded in operation S610 to processing units (S620). As described above, since the loaded data may be distinguished into non-zero elements using the quantization information, the distinguished non-zero elements may be transmitted to each of the plurality of processing units. The processing units that perform matrix computation may perform computation of the non-zero elements of the first and third target matrices.

As described above, according to the embodiment of the present disclosure, data is loaded through memory access in accordance with a data size of a matrix. Therefore, memory access efficiency is enhanced, and the number of memory accesses is reduced, thereby reducing power consumption.

Also, according to the embodiment of the present disclosure, data sizes of matrices are standardized to correspond to multiples or divisors of a unit data block size loaded through memory access, and thus data of a plurality of matrices can be loaded simultaneously. Therefore, memory access efficiency can be further enhanced.

Meanwhile, according to an embodiment, the device for processing a matrix may load the non-zero elements of the first target matrix from the memory using the matrix index information of the first target matrix including quantization information of the first target matrix, count information of the non-zero elements, and the position information of the non-zero elements.

Here, a size of the loaded data may be determined in accordance with the quantization information and count information of the first target matrix, and the loaded data may be distinguished into the non-zero elements using the quantization information or count information.

For example, when the quantization bits of the first target matrix are 16 bits and the number of non-zero elements is three, 48-bit data may be loaded from the memory at once through memory access. The loaded 48-bit data may be divided into 16-bit units, and each of the divided 16-bit units of data may correspond to a non-zero element.

In operation S610, the device for processing a matrix may load elements of the second target matrix that are computed with the first target matrix from the memory. Here, the position information of the first target matrix may be used to load only the elements that are multiplied by the non-zero elements of the first target matrix among the elements of the second target matrix from the memory.

Then, the device for processing a matrix may transmit the data loaded in operation S610 to processing units. As described above, since the loaded data may be distinguished into each of non-zero elements using the quantization information, the distinguished non-zero elements may be transmitted to the plurality of processing units. The processing units that perform matrix computation may perform computation of the non-zero elements of the first and second target matrices.

### Second Embodiment

As described above, processing units that perform matrix computation load matrix data from a memory using matrix index information of a matrix which is a computation target, that is, an operand, and perform matrix computation. Matrix computations are mostly performed through multiplication and accumulation between elements of matrices. Sparse matrices include more zero elements than non-zero elements. Since multiplying by a zero element yields zero, loading all elements of a matrix that is an operand is inefficient.

Therefore, the present disclosure proposes a method of selectively loading elements required for matrix computation and perform matrix computation. Matrix data is stored in a lower memory such as a main memory, and the stored matrix data is transmitted to processing units through an upper memory such as a cache memory or register. According to an embodiment of the present disclosure, data required for computation among matrix data stored in a lower memory is selectively transmitted to an upper memory or processing units, and the matrix data is processed.

In particular, with an increase in the number of zero elements in a matrix, a size of matrix index information may become larger than a size of matrix data. According to an embodiment of the present disclosure, since matrix data required for computation may be selectively transmitted to an upper memory or processing units while matrix index information is not transmitted from a lower memory to an upper memory or processing units, the speed and efficiency of matrix computation can be improved.

Hereinafter, embodiments of the present disclosure will be described in detail with reference to accompanying drawings.

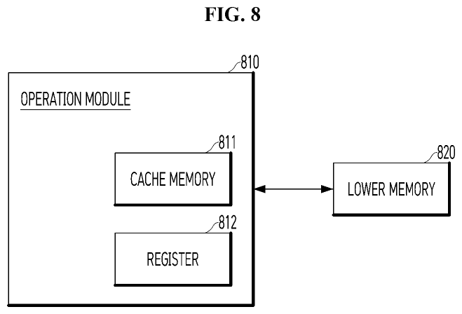

FIG. 8 is a diagram illustrating a device for processing matrix data according to an embodiment of the present disclosure, and the device for processing matrix data may be a computing device including a general-purpose processor or an artificial intelligence accelerator.

Referring to FIG. 8, the device for processing matrix data includes a operation module 810 and a lower memory 820. The operation module 810 includes an upper memory and a plurality of processing units for parallel computation. The upper memory may be a cache memory 811, a register 812, a buffer memory, etc., and the lower memory is a main memory, which may be a memory including a controller with a computation function or a processing-in-memory (PIM).

The operation module 810 generates index information of a matrix and may generate the matrix index information using various matrix indexing methods such as CSR or the like. According to an embodiment, this matrix index information may include position information of non-zero elements in the matrix, count information of the non-zero elements, size information of the matrix, and the like. The matrix index information may be stored in the lower memory 820 together with matrix data, that is, elements of the matrix.

The device for processing matrix data loads elements of a plurality of matrices stored in the lower memory 820 and performs computation. Here, the computation may be a multiplication operation on the elements of the matrices.

According to an embodiment, when the device for processing matrix data performs computation of first and second matrices, elements of the first and second matrices stored in the lower memory 820 may be loaded, and the operation module 810 may perform computation of the first and second matrices using the loaded elements. Here, the device for processing matrix data may selectively load only elements required for computation of the first and second matrices among the elements of the first and second matrices rather than loading all the elements of the first and second matrices. To selectively load the elements required for computation of the first and second matrices, matrix index information may be used.

As described above, computation is not required for elements whose multiplication operation results for accumulation are zero. Accordingly, elements required for computation may be elements of the first and second matrices whose multiplication operation results are not zero.

Alternatively, according to an embodiment, the device for processing matrix data may use the matrix index information of the first and second matrices to load non-zero elements among the elements of the first and second matrices stored in the lower memory and load memory address values of the non-zero elements, thereby performing computation of the first and second matrices.

Among the loaded non-zero elements, those selected in accordance with memory address values may be provided to the operation module 810.

As described above, according to an embodiment of the present disclosure, even when the operation module does not request required specific matrix data using matrix index information, the matrix data required for computation is selectively transmitted from the lower memory to the upper memory or the operation module. This eliminates delays in matrix computation caused by the transmission and reception of matrix index information, thereby improving the speed and efficiency of matrix computation.

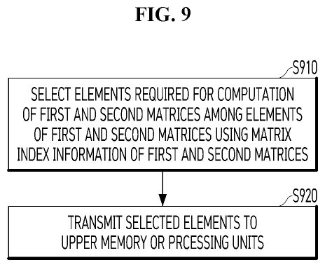

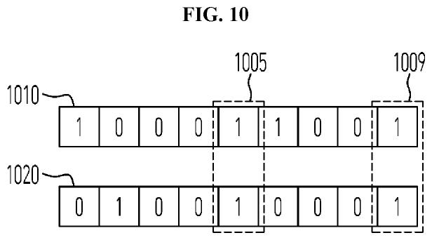

FIG. 9 is a diagram illustrating a method of transmitting matrix data according to an embodiment of the present disclosure, and FIG. 10 is a diagram illustrating a method of selecting elements required for computation. In FIGS. 9 and 10, a method of transmitting matrix data performed in a lower memory will be described as an embodiment.

Referring to FIG. 9, a lower memory according to an embodiment of the present disclosure selects elements required for computation of first and second matrices among elements of the first and second matrices using matrix index information of the first and second matrices (S910). As described above, the elements required for computation are elements of the first and second matrices whose multiplication operation results are non-zero, and the matrix index information may include position information of non-zero elements of the first and second matrices.

The position information of the non-zero elements may be represented as bitstrings. When the first and second matrices are 3×3 matrices composed of nine elements, the bitstrings may be composed of nine bit values as shown in FIG. 10. A first bitstring 1010 represents position information of the first matrix, and a second bitstring 1020 represents position information of the second matrix. The bitstrings include bit values corresponding to each of positions of the elements in the matrices. 0 may be assigned to bit values corresponding to positions of zero elements in the matrices, and 1 may be assigned to bit values corresponding to positions of non-zero elements in the matrices. From the first bitstring 1010, it may be identified that the number of non-zero elements among the elements of the first matrix is four and first, fourth, fifth, and ninth elements of the first matrix are non-zero elements.

In the example of FIG. 10, fifth elements 1005 and ninth elements 1009 of the first and second matrices are common non-zero elements. When a multiplication operation is performed between the elements of the first and second matrices, the lower memory may select the fifth elements 1005 and the ninth elements 1009 of the first and second matrices as elements required for computation because only multiplication operation results of the fifth elements 1005 and ninth elements 1009 of the first and second matrices are not zero. In other words, among the non-zero elements of the first and second matrices, both element values that are not zero at positions corresponding to each other may be selected as elements required for computation.

Referring back to FIG. 9, the lower memory transmits the selected elements to an upper memory or processing units (S920). Here, the lower memory may generate a third matrix including the selected elements and transmit the elements of the third matrix to the upper memory or processing units. In other words, the lower memory may generate a new matrix composed of the selected elements and transmit the selected elements to the upper memory or processing units.

Meanwhile, according to embodiments, the lower memory may use the matrix index information to determine the number of computations required for the elements of the first and second matrices and may consecutively transmit the data selected in operation S910 to the upper memory or processing units through the burst mode or the like in accordance with the number of required computations in operation S920. The number of required computations may be determined in accordance with the number of elements required for computation. In the foregoing example, the lower memory may consecutively transmit the fifth elements and the ninth elements of the first and second matrices to the upper memory or processing units.

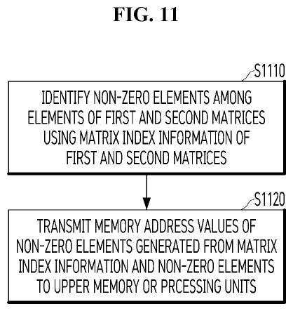

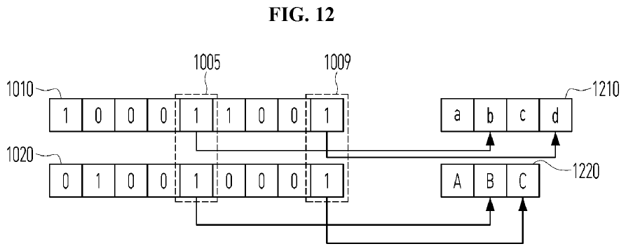

FIG. 11 is a diagram illustrating a method of transmitting matrix data according to another embodiment of the present disclosure, and FIG. 12 is a diagram illustrating memory address values of non-zero elements. In FIGS. 11 and 12, a method of transmitting matrix data performed in a lower memory will be described as an embodiment.

Referring to FIG. 11, a lower memory according to an embodiment of the present disclosure identifies non-zero elements among elements of first and second matrices using matrix index information of the first and second matrices (S1110).

The lower memory may store non-zero elements among elements of a plurality of matrices including the first and second matrices, and the lower memory may determine non-zero elements using matrix index information including at least one of count information and position information of non-zero elements of the plurality of matrices.

Also, the lower memory according to an embodiment of the present disclosure transmits memory address values of the non-zero elements which are generated from the matrix index information, and the non-zero elements to the upper memory or processing units (S1120).

Here, the memory address values may be address values of all non-zero elements transmitted to the upper memory or processing units. Alternatively, according to embodiments, the memory address values may be address values of non-zero elements required for computation of the first and second matrices among the non-zero elements of the first and second matrices. As described above, the non-zero element required for computation correspond to non-zero elements of the first and second matrices whose multiplication operation results are not zero.

Among the non-zero elements transmitted to the upper memory, those selected in accordance with the memory address values may be transmitted to processing units, and the selected non-zero elements may be consecutively transmitted to processing units. When the memory address values are address values of non-zero elements required for computation of the first and second matrices as described in the foregoing example, non-zero elements required for computation of the first and second matrices may be selectively transmitted to processing units among the non-zero elements transmitted to the upper memory.

The lower memory generates memory address values of the non-zero elements. For example, as shown in FIG. 12, when first and second bitstrings 1010 and 1020 representing position information of the first and second matrices are given and non-zero elements 1210 and 1220 of the first and second matrices are a, b, c, and d and A, B, and C, memory address values may be assigned to each of the non-zero elements, increasing by one from a first element to the last element. When the first non-zero element “a” of the first matrix has a memory address of 1, the second non-zero element “b” may have a memory address of 2, the third non-zero element “c” may have a memory address of 3, and the fourth non-zero element “d” of the first matrix may have a memory address of 4. When the first non-zero element “A” of the second matrix has a memory address of 100, the second non-zero element “B” may have a memory address of 101, and the third non-zero element “C” may have a memory address of 102.

In this example, among the non-zero elements a, b, c, d, A, B, and C of the first and second matrices transmitted to the upper memory, b and B that are fifth elements 1005 of the first and second matrices and d and C that are ninth elements 1009 may be selected in accordance with memory address values and transmitted to processing units.

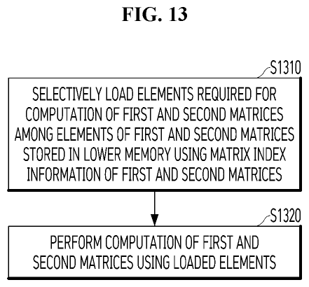

FIG. 13 is a diagram illustrating a method of processing matrix data according to an embodiment of the present disclosure.

Referring to FIG. 13, a device for processing matrix data according to an embodiment of the present disclosure selectively loads elements required for computation of first and second matrices among elements of the first and second matrices stored in a lower memory using matrix index information of the first and second matrices (S1310). The elements required for computation may be loaded into an upper memory or processing units.

Then, the loaded elements are used to perform computation of the first and second matrices (S1320).

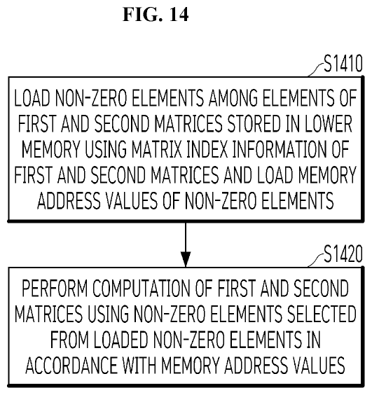

FIG. 14 is a diagram illustrating a method of processing matrix data according to another embodiment of the present disclosure.

Referring to FIG. 14, a device for processing matrix data according to an embodiment of the present disclosure loads non-zero elements among elements of first and second matrices stored in a lower memory using matrix index information of the first and second matrices and loads memory address values of the non-zero elements (S1410). The non-zero elements and the memory address values may be loaded into an upper memory.

Non-zero elements selected among the loaded non-zero elements in accordance with the memory address values may be used to perform computation of the first and second matrices (S1420). As described above, the memory address values are address values of non-zero elements required for computation of the first and second matrices among the loaded non-zero elements, and the non-zero elements required for computation may correspond to non-zero elements of the first and second matrices whose multiplication operation results are not zero.

### Third Embodiment

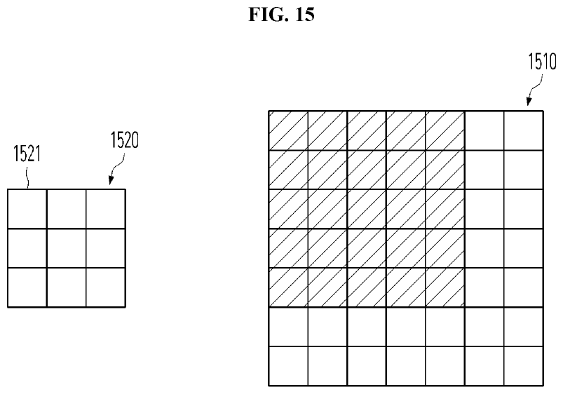

FIG. 15 is a diagram illustrating a convolution operation of a matrix.

As shown in FIG. 15, when a convolution operation is performed between a first operand matrix 1510 and a second operand matrix 1520, the second operand matrix 1520 is shifted in accordance with a stride value, and a computational area for each element of the second operand matrix 1520 is determined in the first operand matrix 1510. Here, the computational area is an area in the first operand matrix 1510 including elements that are computed with each of the elements of the second operand matrix 1520. The computational area may vary depending on the elements of the second operand matrix 1520. In FIG. 15, the grids of the first and second operand matrices 1510 and 1520 represent elements of the first and second operand matrices 1510 and 1520.

When a convolution operation is performed between the 7×7 first operand matrix 1510 and the 3×3 second operand matrix 1520 shown in FIG. 15, a computational area in the first operand matrix 1510 for, as an example, a first element 1521 of the second operand matrix 1520 corresponds to a shaded area in the first operand matrix 1510. In other words, the first element 1521 of the second operand matrix 1520 is computed with some elements included in the computational area rather than all the elements included in the first operand matrix 1510.

In this case, it is unnecessary to load all the elements included in the first operand matrix 1510 for computation with the first element 1521 of the second operand matrix 1520, and it is efficient to selectively load and use some elements included in the computational area of the first operand matrix 1510 for computation.

Therefore, the present disclosure proposes a matrix processing method of generating matrix index information of the elements included in the computational area of the first operand matrix 1510 and selectively loading the elements included in the computational area of the first operand matrix 1510 for computation using the matrix index information.

In particular, an embodiment of the present disclosure proposes a method of generating matrix index information of a computational area using non-zero elements included in the computational area on the basis of the fact that zero elements among elements included in the computational area are also unnecessary. The matrix index information of the computational area may be generated in accordance with various existing matrix index information generation algorithms such as CSR and the like.

The method of generating matrix index information and the matrix processing method according to an embodiment of the present disclosure may be performed by a computing device including a memory and a processor electrically connected to the memory, and the processor may perform a process for generating matrix index information and processing a matrix.

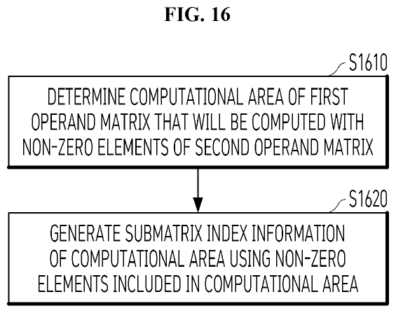

FIG. 16 is a diagram illustrating a method of generating matrix index information according to still another embodiment of the present disclosure.

Referring to FIG. 16, the computing device according to an embodiment of the present disclosure determines a computational area that is computed with non-zero elements of a second operand matrix, in a first operand matrix (S1610). As described above, the computational area is an area in the first operand matrix including elements that are computed with each of elements of the second operand matrix, and may be determined in accordance with a computation method, such as a convolution operation, a transformer operation, etc., sizes of the first and second operand matrices, and the like.

Then, the computing device generates submatrix index information of the computational area using non-zero elements included in the computational area (S1620). The submatrix index information includes count information of the non-zero elements included in the computational area and position information of the non-zero elements in the computational area.

According to an embodiment, the computing device may generate new matrix index information from the non-zero elements included in the computational area or generate submatrix index information by updating full matrix index information generated from non-zero elements included in the first operand matrix, in accordance with the non-zero elements included in the computational area. In other words, the computing device may generate submatrix index information from the full matrix index information which is already-generated matrix index information of the first operand matrix. The computing device may generate submatrix index information by updating the already-generated full matrix index information in accordance with the second operand matrix that is computed with the first operand matrix, and the computational area of the first operand matrix that varies depending on a computation method and the like.

The full matrix index information includes count information of non-zero elements included in the first operand matrix and position information of the non-zero elements in the first operand matrix and may be generated in accordance with various index information generation methods. For example, the full matrix index information may be generated in accordance with CSR or in the form of a bitstring including a first bitstring indicating count information of the non-zero elements and a second bitstring indicating position information of the non-zero elements. Also, the submatrix index information is represented in the same type as the full matrix index information.

Since the number of non-zero elements included in the first operand matrix differs from the number of non-zero elements included in the computational area, the count information included in the full matrix index information is updated in accordance with the number of non-zero elements included in the computational area. Also, since position information of non-zero elements included in the computational area is determined on the basis of the computational area, position information included in the full matrix index information is also updated in accordance with positions of the non-zero elements in the computational area.

Meanwhile, in operation S1620, the computing device may generate memory address values of the non-zero elements included in the computational area using the submatrix index information. According to an embodiment, consecutive memory address values may be generated. The computing device may identify the positions of the non-zero elements included in the computational area using the submatrix index information and generate the memory address values of the non-zero elements included in the computational area as consecutive values such that the non-zero elements included in the computational area may be consecutively loaded in the burst mode or the like.

According to an embodiment of the present disclosure, elements included in a computational area of a second operand matrix that is computed with a first operand matrix are selectively loaded in accordance with matrix index information, thereby reducing the number of memory accesses.

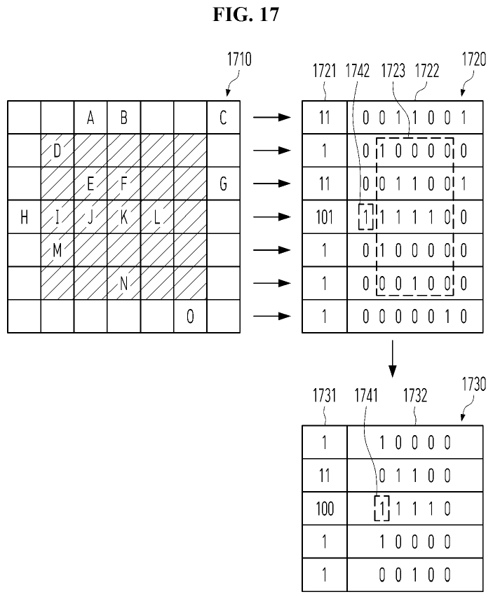

FIG. 17 is a diagram illustrating a method of generating submatrix index information according to an embodiment of the present disclosure.

Referring to FIG. 17, according to an embodiment, full matrix index information of a first operand matrix 1710 may be a bitstring including first bitstrings 1721 representing count information of non-zero elements and second bitstrings 1722 representing position information of the non-zero elements. Also, the first and second bitstrings 1721 and 1722 include count information and position information of non-zero elements in each row of the first operand matrix 1710. In other words, the first and second bitstrings 1721 and 1722 may be generated for each row of the first operand matrix 1710. According to embodiments, the full matrix index information may include first and second bitstrings including count information and position information of non-zero elements in each column of the first operand matrix 1710.

Among grid units of the first operand matrix 1710, grid units with any alphabet letter correspond to non-zero elements, and grid units without any alphabet letter correspond to zero elements. Since the number of non-zero elements A, B, and C in a first row of the first operand matrix 1710 is three, a bit value of the first bitstring 1721 is “11,” and a bit value of the second bitstring 1722 is “0011001.” The second bitstring 1722 may be composed of bits corresponding to each of elements of the first operand matrix 1710, and the first operand matrix 1710 is a 7×7 matrix. Accordingly, 7 bits are assigned to the second bitstrings 1722. Also, depending on whether an element is a zero element or a non-zero element, a bit value corresponding to the element may vary.

When a computational area is determined as a shaded area in the first operand matrix 1710 due to computation with a second operand, a computing device may remove count information and position information of non-zero elements in rows or columns not included in the computational area from the first and second bitstrings 1721 and 1722 of the full matrix index information 1720 and update the first bitstrings 1721 in accordance with the number of non-zero elements included in the computational area, thereby generating submatrix index information 1730.

In the second bitstrings 1722 of the full matrix index information 1720, bits corresponding to the computational area are those included in a broken line 1723, and the bits included in the broken line 1723 correspond to second bitstrings 1732 of the submatrix index information 1730. Since a size of the computational area is 5×5, the submatrix index information 1730 includes first and second bitstrings 1731 and 1732 corresponding to five rows. The first bitstrings 1731 of the submatrix index information 1730 include count information of non-zero elements included in each of rows of the computational area.

In the first and second bitstrings 1721 and 1722 of the full matrix index information 1720, bits corresponding to first and last rows and first and last columns of the first operand matrix 1710 are deleted, and the first bitstrings 1721 of the full matrix index information 1720 are updated in accordance with the number of non-zero elements included in the computational area, thereby generating the submatrix index information 1730.

The computing device may use the submatrix index information 1730 to generate memory address values of the non-zero elements included in the computational area in units of rows or columns of the computational area, and according to an embodiment, may generate consecutive memory address values. For example, consecutive values are assigned as memory address values of non-zero elements I, J, K and L included in a third row of the computational area. In other words, the computing device generates consecutive memory address values of non-zero elements in the second bitstrings 1732 of the submatrix index information 1730 in the order from the most significant bit to the least significant bit.

Here, a starting memory address value in each row or column of the computational area is a memory address value of a first non-zero element in the row or column of the computational area and corresponds to a memory address value of a first bit in each of the second bitstrings 1732 of the submatrix index information 1730. Here, the first bit corresponds to the most significant bit representing a non-zero element in each of the second bitstrings 1732 of the submatrix index information 1730.

Also, when there is a second bit that is a more significant bit than the first bit in each of the second bitstrings 1722 of the full matrix index information, that is, when there is a second bit that is a more significant bit than the first bit in the pre-update second bitstrings 1722, the computing device may increase the starting memory address value in accordance with the number of second bits. For example, one second bit 1742 that is a more significant bit than a first bit 1741 in a 3^{rd} second bitstring of the submatrix index information 1730 exists in a 4^{th} second bitstring of the full matrix index information 1722, a starting memory address value of a non-zero element corresponding to the first bit 1741 in the 3^{rd} second bitstring of the submatrix index information may increase by 1. Therefore, the starting memory address value of non-zero elements in the third row of the computation area may be larger by 1 than starting memory address values of non-zero elements in other rows of the computational area.

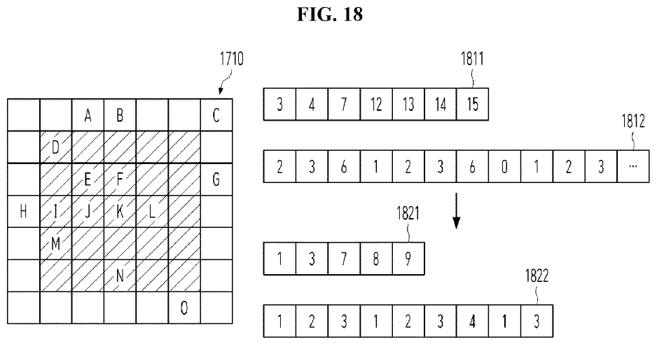

FIG. 18 is a diagram illustrating a method of generating submatrix index information according to another embodiment of the present disclosure.

FIG. 18 shows an embodiment in which submatrix index information is generated from full matrix index information of a first operand matrix 1710 generated according to CSR.

According to a CSR algorithm, matrix index information including row index information and column index information is generated. The row index information includes cumulative information of the number of non-zero elements in each row, and the column index information includes position information of non-zero elements in each row.

Since the number of non-zero elements in a first row of the first operand matrix 1710 is 3, the number of non-zero elements in a second row is 1, and the number of non-zero elements in a third row is 3, index values included in row index information 1811 of full matrix index information have an increasing pattern of 3, 4, and 7. In the first row, non-zero elements are at third, fourth, and seventh columns. When first to seventh columns correspond to index values of 0 to 6, respectively, index values included in column index information 1812 of the full matrix index information have a pattern of 2, 3, and 6.

Subsequently, when a computational area is determined as a shaded area in the first operand matrix 1710 due to computation with a second operand, a computing device may generate updated row index information 1821 and updated column index information 1822 in accordance with non-zero elements included in the computational area.

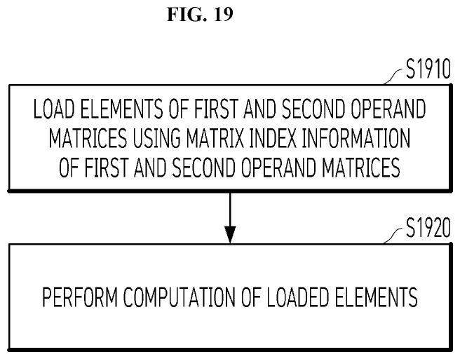

FIG. 19 is a diagram illustrating a method of processing a matrix using matrix index information according to another embodiment of the present disclosure.

Referring to FIG. 19, a computing device according to an embodiment of the present disclosure loads elements of first and second operand matrices using matrix index information of the first and second operand matrices (S1910). Here, the matrix index information of the first operand matrix corresponds to submatrix index information generated using non-zero elements included in a computational area of the first operand matrix, and the computational area of the first operand matrix corresponds to an area of the first operant matrix including elements that are computed with non-zero elements of the second operant matrix. The computing device may load elements of the first and second operant matrices stored in a memory from the memory.

As described above, the submatrix index information may correspond to information obtained by updating full matrix index information generated from non-zero elements included in the first operand matrix in accordance with the non-zero elements included in the computational area. Also, the full matrix index information may include count information of the non-zero elements included in the first operand matrix and position information of the non-zero elements included in the first operand matrix, and the submatrix index information may include count information of the non-zero elements included in the computational area and position information of the non-zero elements in the computational area.

Then, the computing device performs computation of the elements loaded in operation S1910 (S1920). According to an embodiment, the computing device may perform a convolution operation, a transformer operation, etc., of the first and second operand matrices using the loaded elements.

### Fourth Embodiment

As described above, a lightweighting method for a deep learning model such as mixed-precision quantization has been used lately. To efficiently perform such quantization, matrix index information should include feature information of matrix elements such as quantization information. Therefore, the present disclosure proposes a method of generating matrix index information including feature information of matrix elements and a method of processing a matrix using such matrix index information.

According to an embodiment of the present disclosure, matrix index information including at least one feature of matrix elements may be generated. For example, the matrix index information may include feature information such as information on quantization bits of the matrix elements and the like. Here, the quantization bits correspond to the number of bits to which the matrix elements will be quantized. A computing device may quantize matrix elements using such matrix index information. For example, matrix elements whose quantization bits are 16 bits may be quantized as a 16-bit value, and matrix elements whose quantization bits are 8 bits may be quantized as an 8-bit value.

A method of generating matrix index information and a method of processing a matrix according to an embodiment of the present disclosure may be performed by a computing device including a memory and a processor electrically connected to the memory, and the processor may be a general-purpose processor or a separate processor such as a deep learning accelerator for artificial intelligence computation. The memory may store elements of a matrix or matrix index information, and the processor may perform a process of loading the elements or the matrix index information stored in the memory and generating matrix index information or processing the matrix.

In this way, a computing device according to an embodiment of the present disclosure can load a target matrix for a deep learning model and generate matrix index information including feature information of elements of the target matrix. The feature information may include information indicating whether the target matrix is computed with outlier elements of an operand matrix, lightweighting information of the deep learning model, and the like.

Hereinafter, embodiments of the present disclosure will be described in detail with reference to the accompanying drawings.

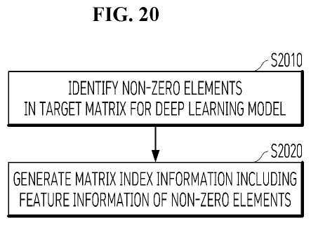

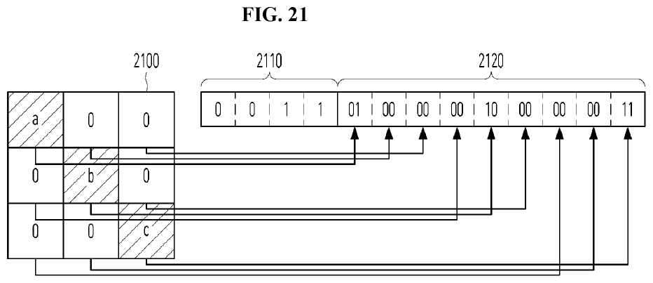

FIG. 20 is a diagram illustrating a method of generating matrix index information according to yet another embodiment of the present disclosure, and FIG. 21 is a diagram showing matrix index information according to another embodiment of the present disclosure.

Referring to FIG. 20, a computing device according to an embodiment of the present disclosure identifies non-zero elements in a target matrix for a deep learning model (S2010). According to an embodiment, the target matrix may be a weight matrix including weight values of an artificial neural network. Since feature information that will be described below is meaningful for non-zero elements, non-zero elements may be determined in operation S2010. However, as described above, matrix index information may include feature information of all elements of the target matrix, and operation S2010 may be selectively performed depending on embodiment.

The computing device generates matrix index information including feature information of the non-zero elements (S2020). As described above, the feature information includes at least one of information indicating whether the target matrix is computed with an outlier element of an operand matrix and lightweighting information of the deep learning model. The lightweighting information is information that may be utilized for performing lightweighting on the deep learning model.

During the computation of the target matrix and the operand matrix, when a non-zero element multiplied by the outlier element of the operand matrix is quantized or quantized to a small number of bits, the multiplication result may be significantly degraded in accuracy. Accordingly, the non-zero element multiplied by the outlier element of the operand matrix should not be quantized or should be quantized to a large number of bits. When the information indicating whether the target matrix is computed with the outlier element of the operand matrix is included in the matrix index information, checking the matrix index information enables the non-zero element that is computed with the outlier element not to be quantized or to be quantized to a large number of bits, thus preventing degradation in the accuracy of the multiplication result. In this aspect, the information indicating whether computation with the outlier element is performed may also be referred to as information indicating whether quantization is possible.

In operation S2020, the computing device may identify a position of the outlier element in the operand matrix and use the position to generate the information indicating whether computation with the outlier element is performed. In other words, the non-zero element that is computed with the outlier element can be determined by identifying the position of the outlier element, and the information indicating whether computation with the outlier element is performed can be generated.

The lightweighting information of the deep learning model may include at least one of quantization information and pruning information of non-zero elements. Here, the quantization information is information for quantization used when non-zero elements are quantized, and may include at least one of whether quantization is applied to non-zero elements, quantization priority of non-zero elements, and quantization bits of non-zero elements. In other words, the information indicating whether quantization is applied to non-zero elements is information indicating whether non-zero elements are elements to be quantized, and the quantization priority of non-zero elements indicates a priority order of the non-zero elements when the non-zero elements are quantized. Also, the quantization bits of non-zero elements are quantization bits of the non-zero elements when the non-zero elements are quantized.

The pruning information is information for pruning indicating whether pruning is applied to non-zero elements, that is, information indicating non-zero elements to be pruned.

The feature information may be set by a user or determined by preset rules, a mixed-precision quantization algorithm, or the like. For example, as described above, the feature information may be generated by determining a position of an outlier element or set in accordance with accuracy of a computational result, importance of elements, and other factors. For a non-zero element with lower importance, quantization priority may be assigned higher, or a smaller number of quantization bits may be set. Alternatively, when the user increases a lightweighting level, a smaller number of quantization bits may be set for non-zero elements, or the number of non-zero elements to be pruned may increase.

According to an embodiment, the matrix index information may be represented as a bitstring including bit values, which may be assigned to each of elements of the target matrix. For example, non-zero elements assigned a bit value of 0 may correspond to elements that are not quantized, not pruned, or not computed with an outlier element, and non-zero elements assigned a bit value of 1 may correspond to elements that are quantized, pruned, or computed with an outlier element. Alternatively, non-zero elements assigned a bit value of 01 may correspond to elements that are quantized to 4 bits, non-zero elements assigned a bit value of 10 may correspond to elements that are quantized to 8 bits, and non-zero elements assigned a bit value of 11 may correspond to elements that are quantized to 16 bits.

The matrix index information may further include at least one of position information and count information of the non-zero elements and size information of the target matrix, and the foregoing bit values may be represented in a form that integrates at least one of the position information, the count information, and the size information with the feature information. The feature information may be provided in a form integrated with various matrix index information representation methods such as CSR and the like.

For example, as shown in FIG. 21, matrix index information of a 3×3 target matrix 2100 including three non-zero elements may include first and second bitstrings 2110 and 2120. According to embodiments, one of the first and second bitstrings 2110 and 2120 may be selectively used as matrix index information.

The first bitstring 2110 includes count information of non-zero elements in the target matrix 2100. Since the number of non-zero elements a, b, and c is three, a bit value of the first bitstring 2110 is “0011” corresponding to three.

The second bitstring 2120 includes feature information and position information of the non-zero elements in the target matrix. The second bitstring 2120 includes bit values assigned to each of elements in the target matrix, and the bit values represent feature information and whether the elements are not zero. Since the bit values are assigned to each of the elements of the target matrix, the bit values represent positions of the non-zero elements. A bit value of 0 may be assigned to zero elements, and bit values other than 0 may be assigned to the non-zero elements.

Two bits may be assigned to each of the elements in the target matrix. Since the number of elements in the target matrix 2100 is nine, the second bitstring 2120 may be composed of 18 bits in total. A bit value assigned to the non-zero element “a” is 01, a bit value assigned to the non-zero element “b” is 10, and a bit value assigned to the non-zero element “c” is 11. Therefore, according to the foregoing example, the non-zero elements a, b, and c correspond to elements quantized to 4 bits, 8 bits, and 16 bits, respectively.

According to an embodiment of the present disclosure, checking matrix index information including feature information of non-zero elements enables efficient lightweighting to be performed on a deep learning model. Also, non-zero elements that are computed with outlier elements are not quantized or are quantized to a large number of bits, thus preventing degradation in the accuracy of a multiplication result.

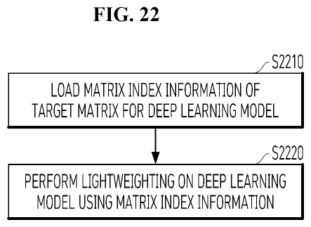

FIG. 22 is a diagram illustrating a method of processing a matrix according to still another embodiment of the present disclosure.

Referring to FIG. 22, a computing device according to an embodiment of the present disclosure loads matrix index information of a target matrix for a deep learning model (S2210). The computing device may load the matrix index information from a memory that stores the matrix index information.

Then, the computing device performs lightweighting on the deep learning model using the loaded matrix index information (S2220). The computing device may perform lightweighting on the deep learning model using feature information of non-zero elements of the target matrix included in the matrix index information and may perform lightweighting by quantizing or pruning elements of the target matrix.

For example, the computing device may not quantize non-zero elements of the target matrix that are computed with outlier elements of an operand matrix or may quantize the non-zero elements to a large number of bits. Alternatively, the computing device may quantize non-zero elements in accordance with quantization bits assigned to each of the non-zero elements. Alternatively, the computing device may change non-zero elements to zero elements using pruning information assigned to each of the non-zero elements.

The above-described technical details may be implemented in the form of program instructions that can be executed by various computing means and recorded on a computer-readable medium. The computer-readable medium may include program instructions, data files, data structures, etc., alone or in combination. The program instructions recorded on the medium may be specially designed and constructed for embodiments or may be known and available to those of ordinary skill in the art of computer software. Examples of the computer-readable recording medium include magnetic media, such as a hard disk, a floppy disk, and magnetic tape, optical media, such as a compact disc (CD)-read only memory (ROM) and a digital versatile disc (DVD), magneto-optical media, such as a floptical disk, and hardware devices specially constructed to store and execute program instructions such as a ROM, a random-access memory (RAM), a flash memory, and the like. Examples of the program instructions include not only machine code generated by a compiler but also high-level code which is executable by a computer using an interpreter or the like. A hardware device may be configured to operate as one or more software modules to perform operations of embodiments, and vice versa.

Although the present disclosure has been described with reference to particular matters, such as detailed components, etc., and limited embodiments and drawings, these are merely provided to help overall understanding of the present disclosure, and the present disclosure is not limited to the embodiments. Those of ordinary skill in the art can make various alterations and modifications from the description. Therefore, the spirit of the present disclosure should not be limited to the described embodiments, and it should be construed that the following claims and all equivalents or equivalent modifications of the claims fall within the scope of the present disclosure.

What is claimed is:

1. A method of generating matrix index information, comprising:
identifying non-zero elements in a target matrix; and
generating matrix index information including quantization information of the target matrix, data size information of the target matrix, and position information of the non-zero elements.

2. The method of claim 1, wherein the matrix index information includes:
a first bitstring indicating the quantization information;
a second bitstring indicating the data size information; and
a third bitstring indicating the position information,
the quantization information is information on quantization bits of the non-zero elements, and
data size of the target matrix is one of preset candidate sizes.

3. The method of claim 2, wherein the data size of the target matrix is a multiple or divisor of a unit data block size loaded through memory access.

4. The method of claim 3, wherein the identifying the non-zero elements comprises adjusting the number of non-zero elements in accordance with the quantization bits such that the data size of the target matrix becomes the multiple or divisor of the unit data block size.

5. The method of claim 3, wherein the identifying the non-zero elements comprises adjusting the quantization bits in accordance with the number of non-zero elements such that the data size of the target matrix becomes the multiple or divisor of the unit data block size.

6. A method of generating matrix index information, comprising:
identifying non-zero elements in a target matrix; and
generating matrix index information including data size information of the target matrix and position information of each of the non-zero elements,
wherein a bitstring indicating the position information includes bits corresponding to each of positions of elements in the target matrix, and
in the bitstring, a bit value corresponding to positions of zero elements in the target matrix and a bit value corresponding to positions of the non-zero elements are different.

7. A method of generating matrix index information, comprising:
identifying non-zero elements in a target matrix; and
generating matrix index information including quantization information of the target matrix, count information of the non-zero elements, and position information of the non-zero elements.

8. The method of claim 7, wherein the matrix index information includes:
a first bitstring indicating the quantization information;
a second bitstring indicating the count information; and
a third bitstring indicating the position information, and
the quantization information is information on quantization bits of the non-zero elements.

9. A method of generating matrix index information, comprising:
identifying non-zero elements in a target matrix; and
generating matrix index information including quantization information of the target matrix and position information of each of the non-zero elements,
wherein a bitstring indicating the position information includes bits corresponding to each of positions of elements in the target matrix, and
in the bitstring, a bit value corresponding to positions of zero elements in the target matrix and a bit value corresponding to positions of the non-zero elements are different.

10. A method of processing a matrix using matrix index information, comprising:
loading non-zero elements of a first target matrix from a memory using matrix index information of the first target matrix; and
transmitting loaded data to processing units,
wherein the matrix index information includes quantization information of the first target matrix, data size information of the first target matrix, and position information of the non-zero elements.

11. The method of claim 10, wherein a size of the loaded data is determined in accordance with the data size information of the first target matrix, and
data size of the first target matrix corresponds to a multiple or divisor of a unit data block size loaded through memory access.

12. The method of claim 11, wherein the loading of the non-zero elements from the memory comprises, when the data size of the first target matrix is smaller than the unit data block size, loading non-zero elements of a second target matrix also.

13. The method of claim 11, wherein the loaded data is distinguished into each of the non-zero elements using the quantization information and transmitted to the processing units, and
the loading of the non-zero elements from the memory comprises loading only elements that are multiplied by the non-zero elements of the first target matrix, among elements of a third target matrix from the memory using the position information.

14. A method of processing a matrix using matrix index information, comprising:
loading non-zero elements of a first target matrix from a memory using matrix index information of the first target matrix; and
transmitting loaded data to processing units,
wherein the matrix index information includes quantization information of the first target matrix, count information of the non-zero elements, and position information of the non-zero elements.

15. The method of claim 14, wherein a size of the loaded data is determined in accordance with the quantization information and the count information.

16. The method of claim 15, wherein the loaded data is distinguished into each of the non-zero elements using the quantization information or the count information and transmitted to the processing units, and
the loading of the non-zero elements from the memory comprises loading only elements that are multiplied by the non-zero elements of the first target matrix, among elements of a second target matrix from the memory using the position information.
